(19) United States
(12) Patent Application Publication
(10) Pub. No.: US 2005/0043951 A1
(43) Pub. Date: Feb. 24, 2005

(54) Voice instant messaging system

(76) Inventor: Eugene Terry Schurter, Fairbury, NE (US)

Correspondence Address: Eugene Terry Schurter, 1002 South Timberlane, Eureka, IL, 61530, US

(21) Appl. No.: 10/616,050

(22) Filed: Jul. 7, 2003

Related U.S. Application Data
(60) Provisional application No. 60/394,541, filed on Jul. 9, 2002.

(51) Int. Cl. G10L 11/00

(52) U.S. Cl. 704/270.1

(57) ABSTRACT

A system and method for extending instant messaging applications to telephony devices using voice recording, voice streaming, voice recognition and voice synthesis with the steps of: generating the speech synthesis of text messages, voice recognition for the performance of Instant Messaging functions, such as selecting a “buddy”, changing status, sending a message, listening to a message, a mechanism for the recording and delivery of voice as part of an instant message that is part of an Instant Messaging system to Instant Messaging clients on electronic text messaging capable devices and telephony devices over networked systems such as the Internet, wireless networks, cellular networks, radio networks, and wireline networks.

### CROSS REFERENCE TO RELATED APPLICATIONS

This application is based on provisional application serial number 60/394,541, filed on Jul. 9, 2002.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of Instant Messaging and more specifically to a system and method for extending instant messaging applications to telephony devices using voice recording, voice streaming, voice recognition and voice synthesis.

Instant Messaging has become a global phenomena with over 100 million users worldwide. Much like email, Instant messaging, or IM, has become a service millions use every day with billions of messages sent each year.

Instant Messaging started as PC based text communications service operating over the Internet. As the popularity of Instant Messaging has grown, the interest and desire to be able to engage in Instant Messaging while not at an Internet connected PC has also grown.

Several means to continue Instant Messaging on mobile devices have emerged, all of which are mobile text based Instant Messaging clients.

By use, statistics, observations and personal frustration the determination that mobile Instant Messaging is unsatisfactory was easy to make. How can this problem be solved? What can be done to make mobile Instant Messaging simple and easy for everyone?

The answer is voice. The majority of mobile devices are primarily voice based devices. It was their founding purpose and still represents the primary use of mobile devices today.

This thinking led to approach of the problem from what many would consider a backwards point of view. However, the exercise proved fruitful as modeling classical text Instant Messaging behavior in a voice only enviroment quickly fell into a natural flow that was simple yet very complete in delivering the full Instant Messaging experience.

With the modeling exercise completed, the next step was to design the system and method necessary to deliver a voice based Instant Messaging experience in conjunction with text (PC) users—as it is expected that PC users will always outnumber mobile voice users in this environment.

The design outline was prepared to address this new “mixed mode” Instant Messaging environment followed by the actual system design necessary to provide a mobile voice based Instant Messaging client service to existing Instant Messaging services.

The final step that was taken to confirm that this unique mobile Instant Messaging service interface would work was the development of a prototype which was completed and highly successful.

Several other means to continue Instant Messaging on mobile devices do exist. Probably the first were text based services for cellular phones, pagers and PDAs that provided an Instant Messaging client on the mobile device built on wireless web, WAP, or wireless Internet technology. These systems are fully functional. Text messages are typed on either a phone keypad or “mini” keyboard, mimicing their big brother PC applications.

The next method of mobile Instant Messaging that emerged is Instant Messaging using SMS. In many ways this method is more desireable as it requires less action on the part of the mobile user to participate in Instant Messaging. These systems are fully functional. Text messages are typed on either a phone keypad or “mini” keyboard, mimicing their big brother PC applications.

Emerging services are centered around more advanced mobile devices with Java (J2ME), Microsoft SmartPhone and other “operating system” capable devices. These devices will provide a more graphically friendly interface than either of the preceding technologies. These systems are fully functional. Text messages are typed on either a phone keypad or “mini” keyboard, mimicing their big brother PC applications.

Looking across the three major mobile Instant Messaging technologies there is one thing that they all have in common—they require the user to type text messages on a “phone” keypad or “mini” keyboard.

This is completely satisfactory for some people and marginally acceptable for others. But for many people these means of input are considered unacceptable and therefore, they do not have a useful means to engage in Instant Messaging from their mobile device.

### BRIEF SUMMARY OF THE INVENTION

The primary object of the invention is to provide a system and method to conduct Instant Messaging on any telephony device.

Another object of the invention is to provide a system and method to conduct Instant Messaging client behavior using only voice.

Another object of the invention is to provide a system and method to conduct Instant Messaging from any telephony device using an existing Instant Messaging service and account.

A further object of the invention is to provide a system and method to conduct Instant Messaging from any telephony device where anyone that can talk and hear can simply and easily conduct Instant Messaging.

Yet another object of the invention is to provide a system and method for Instant Messaging users, using text-based messaging, to perform Instant Messaging with Instant Messaging users using a voice based client.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a system and method for extending instant messaging applications to telephony devices using voice recording, voice streaming, voice recognition and voice synthesis comprising the steps of: generating the speech synthesis of text messages, voice recognition for the performance of Instant Messaging functions, such as selecting a “buddy”, changing status, sending a message, listening to a message, a mechanism for the recording and delivery of voice as part of an instant message that is part of an Instant Messaging system to Instant Messaging clients on electronic text messaging capable devices and telephony devices over networked systems such as the Internet, wireless networks, cellular networks, radio networks, and wireline networks.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

A system and method for extending instant messaging applications, such as AOL Instant Messenger (AIM), Yahoo! Instant Messenger and Microsoft Instant Messenger to telephony devices using voice recording, voice streaming, voice recognition, and voice synthesis.

The system and method enables connection to an existing instant messaging system and an existing instant messaging account from a telephony device such as a cellular phone, touchtone telephone, digital telephone, and VoIP phone. The system and method enables an IM user to conduct the normal, interactive dialog(s) and functions typical of such systems solely by voice and audible sound using any telephony device.

The system and method is accessed from a telephony device by calling a phone number(s) or by initiating a unique VOIP session or other telephony session and operates in conjunction with telephony capable networks and protocals such as wireless, wireline, Internet, cellular and radio. There is no unique software or hardware required on the telephony device. The system and method accepts the incoming voice call and logs the user onto their existing IM account, acting as the IM client to the IM server.

The system and method supports unlimited, simultaneous sessions for each individual using the system and for any multiple of individuals using the system in any combination.

The system and method provides the mechanism for the automatic conversion of instant messaging shorthand to both the phonetic equivelant and longhand translation.

The system and method further comprises the automatic translation of instant messaging “emoticons” to representative sounds or “emotisounds”.

The system and method receives text messages from a computer instant messaging client. The system and method converts the text messages to voice using voice synthesis and then broadcasts the synthesized voice over the telephony connection as an audio signal to the telephony device where the telephony device user hears the audio synthesis of the text message.

The system and method captures the voice signal from the telephony device as a message. The message is then streamed into the electronic instant messaging capable client voice channel, sound hardware or sound system along with the telephony user's identification, as text, on the instant messaging system. The instant messaging recipient sees the identification for the message as text in the instant messaging client and hears the voice instant message.

The system and method captures the voice signal from the first telephony device as a message. The message is then directly broadcast over the telephony connection as an audio signal to the second telephony device.

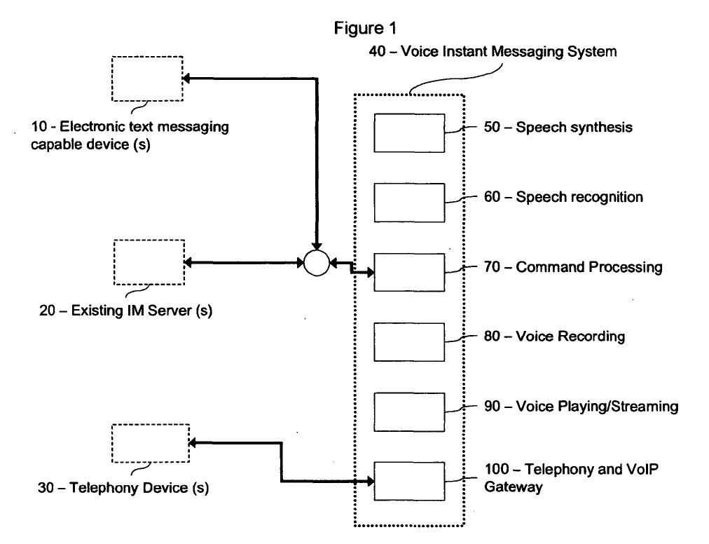

Turning to FIG. 1 there is shown the schematic overview of the system and method. External objects, objects 10, 20, and 30 are differentiated by dashed lines. Objects 10 and 30 are the user inputs and outputs of the system.

Object 10 represents devices that are or can be used for text instant messaging, such as computers, internet appliances, text capable mobile devices, PDAs, and pagers. The most common text messaging device is the computer.

Object 30 represents the devices that this system and method extends voice based instant messaging to and includes all telephony devices. The device the system and method is primarily focused on is the mobile phone.

Object 20 represents external instant messaging services such as Microsoft Windows Messenger, Yahoo Messenger and AOL Messenger.

Objects 40 is the group object of the objects of the system and method. The objects of the system and method are the primary categories of the functions that are embodied in the system and method.

Object 50 is speech synthesis, commonly referred to as Text-to-Speech, where text information such as message, status, buddy names is converted to computer generated voice audio using speech libraries (different “voices”) for output to a telephony device.

Object 60 is speech, or voice, recognition where audio information such as spoken words, phrases, and sentences are processed in order to perform the desired action. The audio information is received from input on the telephony device and is then logically solved against the available command and function set of the existing state and the resulting action appropriate to the command or function is performed such as selecting a buddy to message to, changing parameters of the users instant messaging environment, adding predefined content and setting the state for message recording.

Object 70, command processing, represents the necessary support functions that must be performed by the system and method to complete a given instant messaging task such as handling of the instant messaging session with the external instant messaging system, retrieval of account, preference and behavior settings from data storage, qeueing of online and offline messages, and message delivery to electronic instant messaging capable devices.

Object 80 is the voice recording function for the recording of audio messages from the telephony device. The telephony user simply speaks their instant message and the voice recording function records their message as an electronic audio element. The electronic audio element can be managed in mutiple ways such as saved as a file, saved as a data element, saved as an in-memory element, streamed through with delay, and streamed through without delay.

Object 90 is the voice playing and streaming function for the playing of audio messages from Object 80 to any electronic instant messaging capable device through the audio playback means the device has available such as speakers and headphones and any telephony device.

Object 100 is the telephony and VoIP gateway which performs all management, conversion and delivery of outgoing audio such as messages, system responses, and events to telephony devices.

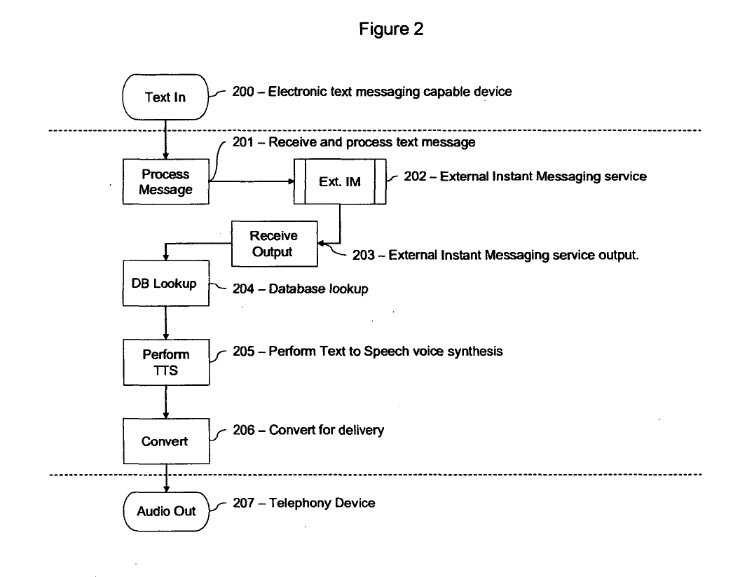

In accordance with the present invention, FIG. 2 shows the basic flow of the system and method originating with an electronic text messaging capable device.

Starting at Step 200, a text message is generated on the electronic text instant messaging capable device. The message is received and processed at Step 201 and any elements and functions of the system and method appropriate to the message are processed. The message is then sent to to the external instant messaging service for normal processing in that system.

At Step 203 the message is received from the external instant messaging system. This message received from the external instant messaging system is now a recipient message were in prior Steps the message was a sender message. In Step 204 recipient information and extended message elements from Step 201 are retrieved for each message.

At Step 205 the message and any extended message elements are converted from text to speech using electronic speech synthesis. Step 206 performs any conversion necessary to deliver the converted message to the telephony device depending on the transport network, technology, and protocal applicable and sends the message to the target telephony device (s) which is Step 207.

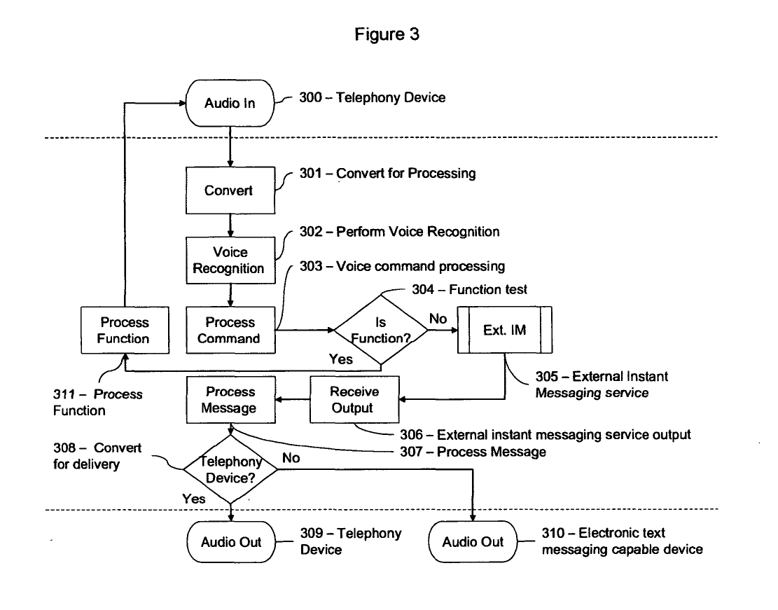

In accordance with the present invention, FIG. 3 shows one expression of the basic flow of the system and method originating with a telephony device.

Starting at Step 300 a message or command is generated on the telephony device by speaking.

At Step 301 the spoken message or command is converted, if necessary, for further processing which is performed in Step 302 where voice recognition is performed on the message or command. The result is processed in Step 303 where the message or command is resolved into either a message or a command and for items determined to be commands, identifies the associated function with the command.

Step 304 routes all functions to the Step 311 for processing and all messages to Step 305.

Step 311 processes all functions, such as changing status, selecting a buddy, changing mode and buzzing and returns the corresponding result back to the originating telephony device as spoken audio.

Step 305 repesents external instant messaging services such as Microsoft Windows Messenger, Yahoo Messenger and AOL Messenger.

Step 306 receives the external instant messaging output. This step is also a transition point as this is where recipient message handling begins in this system flow example.

Step 307 processes the message for delivery to the target device and Step 308 converts the message, if necessary, then routes the message to the appropriate device, either a Telephony device, Step 309 or an Electronic text messaging device, Step 310.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

1. A system and method for extending instant messaging applications to telephony devices using voice recording, voice streaming, voice recognition and voice synthesis comprising the steps of:
generating the speech synthesis of text messages;
voice recognition for the performance of Instant Messaging functions, such as selecting a “buddy”, changing status, sending a message, listening to a message;
a mechanism for the recording and delivery of voice as part of an instant message that is part of an Instant Messaging system to Instant Messaging clients on electronic text messaging capable devices and telephony devices over networked systems such as the Internet, wireless networks, cellular networks, radio networks, and wireline networks.

2. A system and method as described in 1, wherein such system and method is applicable to Instant Messaging systems such as Microsoft Windows Messenger, Yahoo Messenger and AOL Messenger.

3. A system and method as described in 1, wherein such system and method further comprises:
(a) the conversion of graphical emotion elements (Emoticons) to emotion sounds (Emotisounds);
(b) the conversion of Instant Messaging shorthand to their respective, phonetic equivelant;
(c) and the translation of Instant Messaging shorthand to their respective, longhand equivelant;
(d) the selection of voice libraries to customize the speech synthesis ouput;
(e) the playing, streaming, and replaying of a voice message as a sound file on an electronic text messaging capable device or telephony device;
(f) and the playing, streaming and replaying of a voice message as sound on an electronic text messaging capable device or telephony device.

4. A system and method as described in 2, wherein such system and method further comprises:
(a) the use of one or more existing Instant Messenger service(s) account(s);
(b) the use of one of more newly created Instant Messenger service(s) account(s);
(c) and the function of action as a client to one or more existing Instant Messenger service(s).

5. A system and method as described in 1, wherein such system and method further comprises;
(a) support of an individual Instant Messaging session as telephony device to electronic text messaging device and as telephony device to telephony device;
(b) and multiple, simultaneous Instant Messaging sessions of both telephony device to electronic text messaging device and telephony device to telephony device without limitation to number of sessions or type of sessions.
